(19) United States
(12) Patent Application Publication
(10) Pub. No.: US 2011/0100143 A1
(43) Pub. Date: May 5, 2011

(54) Ball Screw and Nut Assembly

(76) Inventor: John Stanley Borza, Shelby Township, MI (US)

(21) Appl. No.: 12/936,268

(22) PCT Filed: Feb. 6, 2009
(86) PCT No.: PCT/US09/33393

§ 371 Date: Oct. 4, 2010

Related U.S. Application Data
(60) Provisional application No. 61/063,721, filed on Feb. 6, 2008.

(51) Int. Cl. F16H 25/22

(52) U.S. Cl. 74/424.82

(57) ABSTRACT

A ball screw and nut mechanism includes a screw having helical grooves with helical ridges therebetween. A nut is formed from at least two portions and has complementary grooves which in combination with the screw grooves define raceways for at least one closed loop of rolling balls. The nut defines at least first and second seams between the two nut portions. The rolling balls circulate in a closed loop to enable the screw to translate in a linear manner relative to the nut. In the region of at least one seam, the grooves in the nut portions are configured so as to at least partially unload the balls as they roll past the seam.

### CROSS REFERENCE TO RELATED APPLICATIONS

This application claims the benefit of U.S. Provisional Application No. 61/063,721 filed Feb. 6, 2008.

### BACKGROUND

Various embodiments of a ball screw and nut assembly are described herein. In particular, the embodiments described herein relate to an improved ball screw and nut assembly.

Screw and nut mechanisms with recirculating balls are commonly used to transform a rotational movement into a linear movement or a linear movement into a rotational movement. The nut can be made in two halves and assembled about the screw. Use of such a split nut may cause undesirable noise and vibration as the balls move across the seams between the two nut halves.

One example of a recirculating ball screw and nut assembly is disclosed in U.S. Pat. No. 7,013,747, which is incorporated herein by reference. U.S. Pat. No. 7,013,747 discloses a unitary nut (2) and a screw (4) complementary threaded in a manner well known in the conventional technology.

U.S. Pat. No. 4,364,282 discloses a screw and nut mechanism. The nut is made of two sheet metal halves. The groove in a cylindrical portion of the nut intermediate the edges of the halves is provided with a recessed portion constituting a return portion of the closed loop over a ridge between two adjacent groove turns in the screw.

U.S. Pat. No. 4,474,073 discloses a spindle drive assembly with recirculating balls. The nut includes at least one compensating gap and a clamping means to apply a circumferential force to the nut to control the width of the compensating gap in such a way as to prevent the unloading of the balls as they traverse the gap.

### SUMMARY

The present application describes various embodiments of a ball screw and nut assembly. One embodiment of the ball screw and nut mechanism includes a screw having helical grooves with helical ridges therebetween. A nut is formed from at least two portions and has complementary grooves which in combination with the screw grooves define raceways for at least one closed loop of rolling balls. The nut defines at least first and second seams between the two nut portions. The rolling balls circulate in a closed loop to enable the screw to translate in a linear manner relative to the nut. In the region of at least one seam, the grooves in the nut portions are configured so as to at least partially unload the balls as they roll past the seam.

Other advantages of the ball screw and nut assembly will become apparent to those skilled in the art from the following detailed description, when read in light of the accompanying drawings.

### BRIEF DESCRIPTION OF THE DRAWINGS

FIG. 1 is a schematic plan view of a portion of the ball screw and nut assembly, showing one the screw in one half of the nut.

FIG. 2 is a schematic cross sectional view taken along the line 2-2 in FIG. 1.

FIG. 3 is an enlarged schematic cross sectional view of a portion of the ball screw and nut assembly illustrated in FIG. 2.

FIG. 4 is an enlarged schematic cross sectional view of a portion of the ball screw and nut assembly taken along the line 4-4 in FIG. 3.

FIG. 5 is an enlarged schematic cross sectional view of an alternate embodiment of the portion of the ball screw and nut assembly illustrated in FIG. 4.

FIG. 6 is an enlarged schematic cross sectional view of a portion of the ball screw and nut assembly taken along the line 6-6 in FIG. 3.

FIG. 7 is a sectional view of a portion of a known embodiment of a vehicle electric power steering assembly.

### DETAILED DESCRIPTION

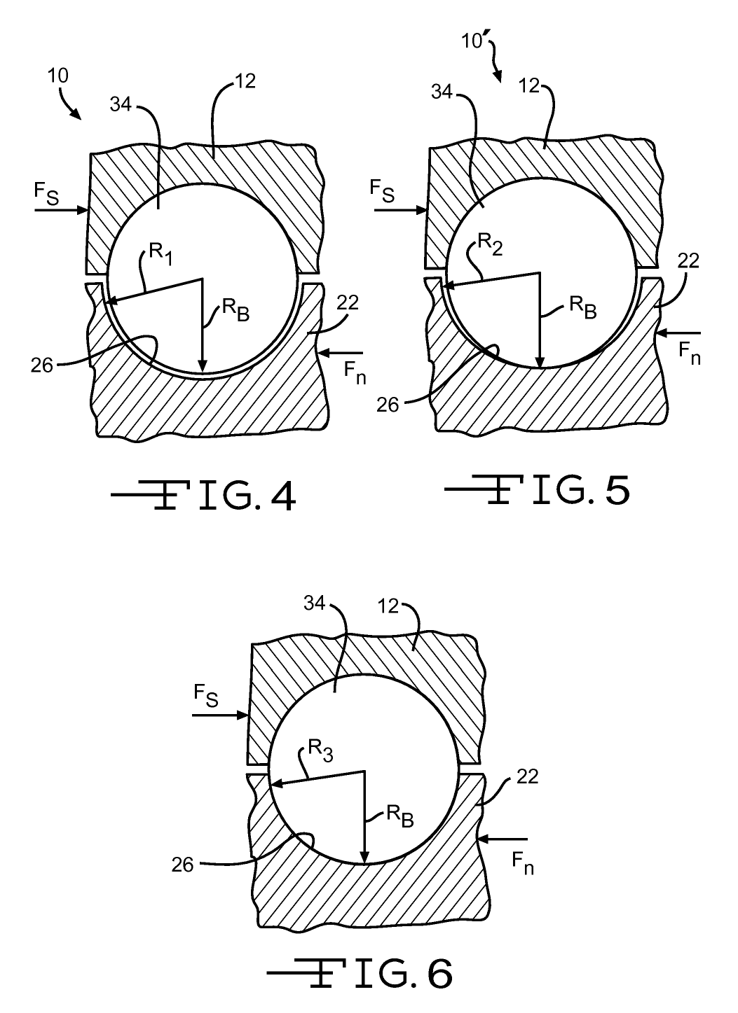

Referring now to FIG. 4, there is illustrated a known embodiment of a vehicle electric power steering assembly, indicated generally at 100. The illustrated vehicle electric power steering assembly 100 is a vehicle electric belt driven rack drive steering assembly and is associated with the front driven wheels (not shown) of the vehicle. The general structure and operation of the electric power steering assembly 100 is conventional in the art.

The illustrated electric power steering assembly 100 includes a vehicle steering wheel 112 and a rotatable input shaft 114 which is operatively coupled in a manner not shown, to the steering wheel 112 for rotation therewith about a steering axis X1. A torque sensor 116 is located inside a pinion housing 118 and encircles the input shaft 112. The torque sensor 116 includes coils (not shown) which respond to the rotation of the input shaft 112 and which generate over electrical lines (not shown) an electrical signal indicative of the direction and magnitude of the applied steering torque.

A torsion bar (not shown) is provided to connect the input shaft 114 to a pinion 122 located inside the pinion housing 118. The torsion bar 120 twists in response to the steering torque applied to the steering wheel 112. When the torsion bar 120 twists, relative rotation occurs between the input shaft 114 and the pinion 122.

The pinion housing 118 is attached to a rack housing, indicted generally at 130. A linearly movable steering member 132 extends axially through the rack housing 130. The steering member 132 is linearly (or axially) movable along a rack axis X2. A rack portion 134 of the steering member 132 is provided with a series of rack teeth (not shown) which meshingly engage gear teeth (not shown) provided on the pinion 122. The steering member 132 further includes a screw portion 140 having an external thread convolution 142. The steering member 132 is connected with steerable wheels (not shown) of the vehicle through tie rods (not shown) located at the distal ends of the steering member 132. Linear movement of the steering member 132 along the rack axis X2 results in steering movement of the steerable wheels as is known manner.

The rack housing 130 has a generally cylindrical configuration and includes a first section 150, a second section 152, and a third section 154. The first section 150 is connected to the second section 152 by suitable means, such as for example by a plurality of bolts and nuts (not shown). Similarly, the second section 154 is connected to the third section 154 by suitable means, such as for example by a plurality of bolts and nuts (only the bolts shown in FIG. 4 by reference numbers 270). The first section 150 is provided with a radially enlarged end 150A, and the third section 154 is provided with a radially enlarged end 154A. The enlarged ends 150A and 154A of the respective sections 150 and 154 cooperate with the second section 152 to define an annular chamber 156. Alternatively, the structure of the rack housing 130 can be other than illustrated if so desired. For example, the rack housing 130 can include less than three sections or more than three sections if so desired.

The steering assembly 100 further includes an electric motor 160 which is drivably connected to a ball nut assembly, indicated generally at 170 for effecting axial movement of the steering member 132 upon rotation of the steering wheel 112. In the event of the inability of the electric motor 160 to effect axial movement of the steering member 132, the mechanical connection between the gear teeth on the pinion 124 and the rack teeth on the rack portion 134 of the steering member 132 permits manual steering of the vehicle. The ball nut assembly 170 is located in the chamber 156 of the rack housing 130 and encircles the screw portion 140 of the steering member 132.

The ball nut assembly 170 further includes a plurality of force-transmitting members 260. The force transmitting members 260 comprise balls (shown in FIG. 4), which are disposed between the internal screw thread convolution of the ball nut and the external thread convolution on the screw portion 140 of the steering member 132. The balls 260 are loaded into the ball nut assembly 170 in a known manner. The ball nut assembly 170 further includes a recirculation passage (not shown) for recirculating the balls 260 upon axial movement of the steering member 132 relative to the ball nut assembly 170.

As used herein, load is defined as force transferred from the screw 12 through the balls 34 to the nut 18. Unloaded is defined as the condition wherein little if any force is transferred from the screw 12 through the balls 34 to the nut 18. For example FIG. 4 is a schematic illustration of a ball 34 in an unloaded state. A screw force F_{S} is transferred to the ball 34, but the ball 34 does not transfer a force to the nut 18, therefore placing the ball 34 in an unloaded condition. In the illustrated embodiment the ball 34 has a radius R_{B} smaller than a radius R₁ of the groove 26.

FIG. 5 is a schematic illustration of an alternate embodiment of the ball screw and nut assembly 10′, wherein the screw force F_{S} is transferred from the screw 12, through the ball 34 to the nut 18. In the illustrated embodiment the ball 34 has a radius R_{B} substantially equal to the radius R₃ of the groove 26.

It will be understood that in an unloaded state, the relative positions of the screw 12, the ball 34, and nut 18 may be other than illustrated in FIGS. 4 and 5, so long as little if any force is transferred from the screw 12 through the balls 34 to the nut 18.

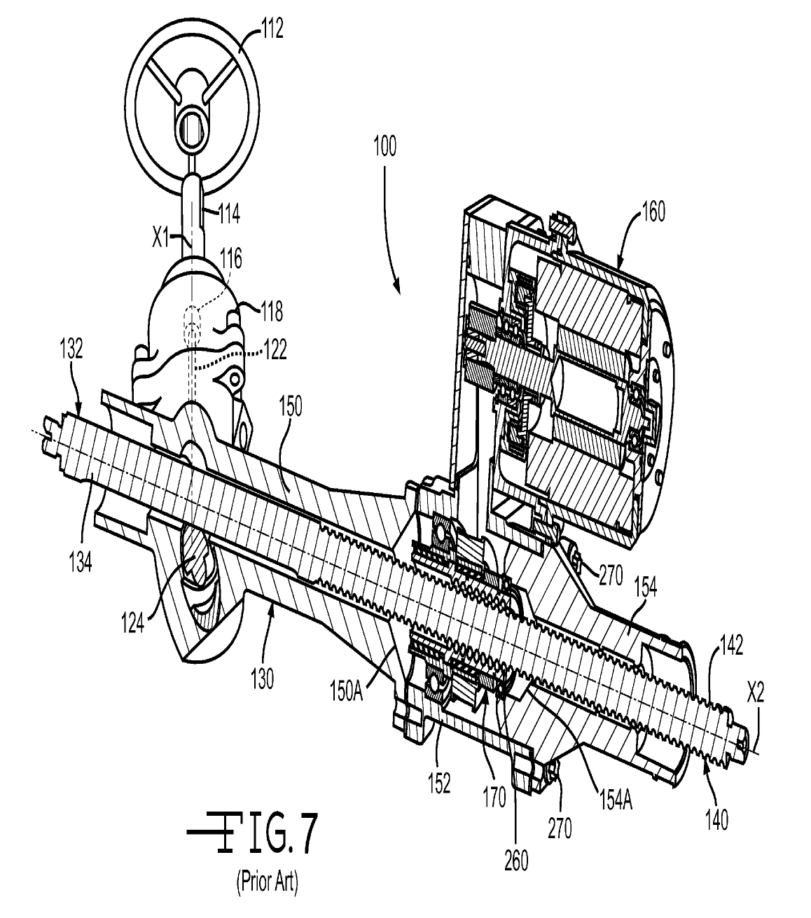

FIG. 6 is a schematic illustration of a ball 34 in a loaded state. The screw force F_{S} is transferred to the ball 34, but the ball 34 does not transfer a force to the nut 18, therefore placing the ball 34 in an unloaded condition. In the illustrated embodiment the ball 34 has a radius R_{B} smaller than a radius R₁ of the groove 26.

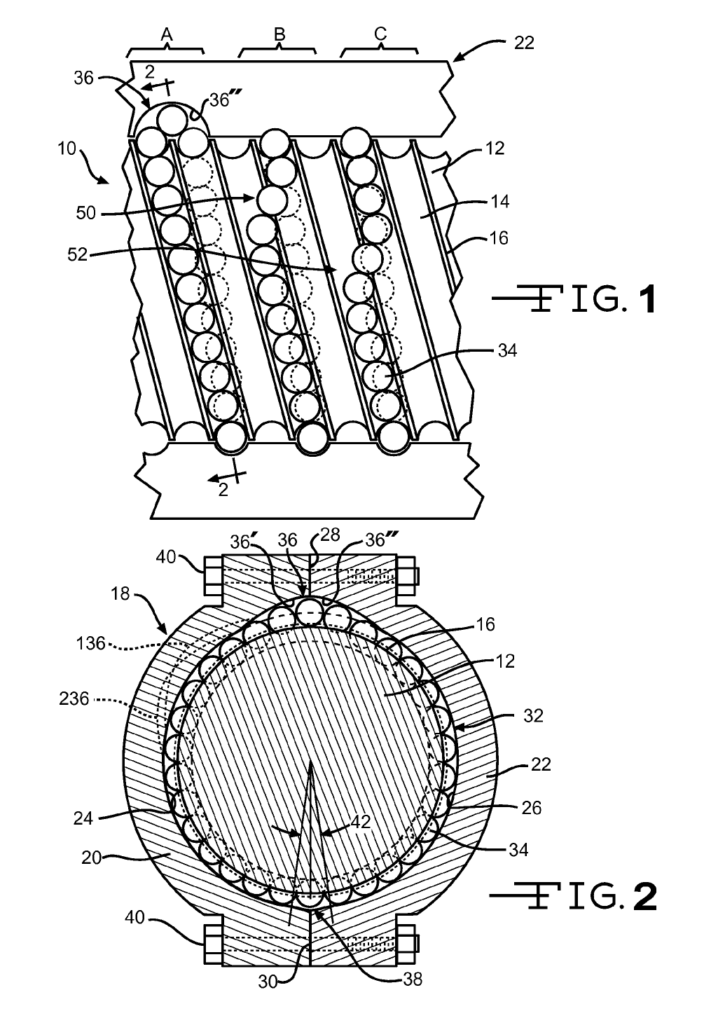

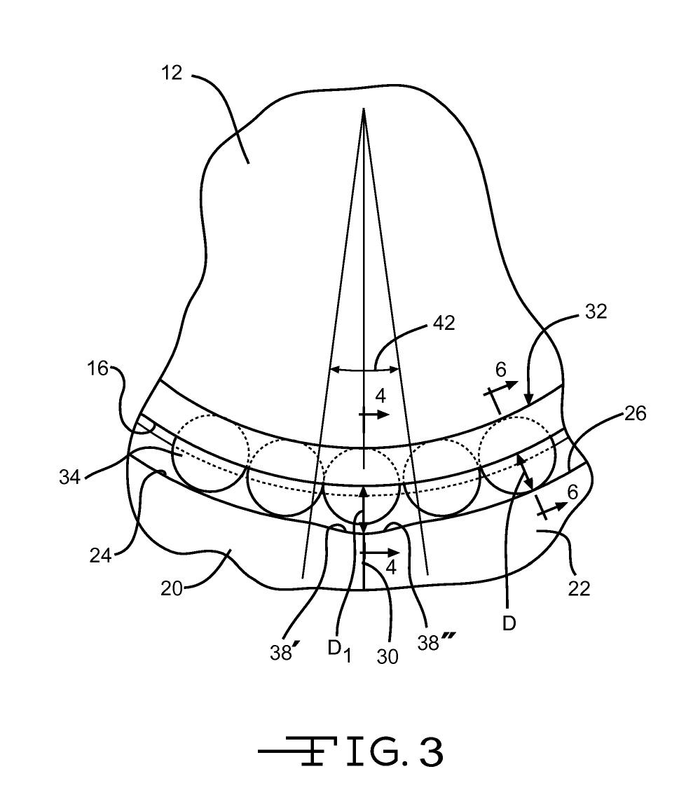

Referring again to the drawings, there is illustrated in FIG. 1 a sectional view of a portion of a first embodiment of a ball screw and nut or ball nut assembly, indicated generally at 10. The illustrated embodiment of the ball screw and nut assembly 10 includes a worm or screw 12. The screw 12 includes a helical groove 14 formed in an outer surface thereof. The helical groove 14 is limited by a helical land or ridge 16. As best shown in FIG. 2, the screw 12 is surrounded by a nut 18 made of two halves or portions; a first portion 20 and a second portion 22. The first and second portions 20 and 22 define halves of the nut 18.

The screw 12 may be formed from any suitable material. Examples of suitable materials include steel, brass, engineered plastics, and aluminum. Any other suitable metal and non-metal may also be used, the selection of which would be determined by the loads anticipated in the particular application, and by routine experimentation.

The first and second portions 20 and 22 are substantially identical and are substantially semi-cylindrical in shape. The first and second portions 20 and 22 each cover or extend around about 180 degrees of the screw 12. Grooves 24, 26 are formed in the inner surfaces of the first and second portions 20 and 22, respectively.

When assembled to form the nut 18, the first and second portions 20 and 22 define first and second longitudinal splits or seams 28 and 30, respectively. Additionally, the grooves 24, 26 of the first and second portions 20, 22 cooperate with the helical groove 14 to define raceways 32 for a plurality of rolling members or balls 34, which circulate in one or more closed loops or circuits, such as shown at A, B, and C in FIG. 1. It will be understood that the number of circuits will be determined by the specific application, the space available, the load and life requirements, and the like.

Referring to FIGS. 1 and 2, a first embodiment of a first recessed portion 36 is formed in the grooves 24 and 26 of the first and second nut portions 20 and 22, respectively. When the first and second portions 20 and 22 are assembled to define the nut 18, the recessed portion 36 provides a recirculation path for the balls 34 over the ridge 16 between two adjacent portions of the helical groove 14 in the screw 12. In the exemplary embodiment illustrated a ball circuit A in FIG. 1, and in FIGS. 2 and 3, the recessed portion 36 is formed at the seam 28. The recessed portion 36 includes first part 36′ formed in the groove 24 of the first nut portion 20 and a second part 36″ formed in the groove 26 of the second nut portion 22, the functions for each will be described in detail below. The recessed portion 36 is formed deep enough to unload the balls 34 and provide clearance for the balls 34 as they pass over the ridge 16.

It will be understood however, that the recessed portion 36 is not required to be formed at a seam 28, 30, as described above. As illustrated in a second embodiment of a ball circuit B in FIG. 1, an alternative location where the balls 34 may pass over the ridge 16 is shown at 50. In the ball circuit B, the recessed portion (shown by the dashed line 136 in FIG. 2) is formed in a groove 24 of the first nut portion 20. Similarly, in a third embodiment of a ball circuit C in FIG. 1, another alternative location where the balls 34 may pass over the ridge 16 is shown at 52. In the ball circuit C, the recessed portion (shown by the dashed line 236 in FIG. 2) is formed in a groove 24 of the first nut portion 20.

A second recessed portion 38 is formed in the grooves 24 and 26 of the first and second nut portions 20 and 22, respectively, such that the rolling balls 34 unload within the second recessed portion 38. The second recessed portion 38 includes first part 38′ formed in the groove 24 of the first nut portion 20 and a second part 38″ formed in the groove 26 of the second nut portion 22,

As best shown in the embodiment illustrated in FIG. 3, the raceway 32 at second recessed portion 38 has a maximum depth D₁ slightly larger than a depth D of the remainder of the raceway 32. As used herein, the depth D and D₁ are measured from the upper surface of the ridge 16. At the second recessed portion 38, the surface (lower surface when viewing FIG. 2) of the nut groove 24, 26 is tapered to the maximum depth D₁ over a distance defined by an arc having an angle 42 of about 10 degrees, centered on the second seam 30. If desired, the surface (lower surface when viewing FIG. 2) of the nut groove 24, 26 of the second recessed portion 38 may be tapered to the maximum depth D₁ over a distance defined by an arc having any other desired angle 42. It will be understood that the angle of the arc 42 may be determined through routine experimentation and may vary from application to application. Factors such as for example, the pitch of the screw 12, the desired load, the speed of rotation, the size of the ball 34, and the size of the nut 18, may be considered to determine the appropriate angle of the arc 42.

Although the second recessed portion 38 is illustrated as being formed at the second seam 30, it will be understood that the second recessed portion 38 may be formed at the first seam 28, or at both the first and second seams 28 and 30 of any desired ball circuit, such as the circuits A, B, and C.

In the embodiment illustrated in FIG. 3, the maximum depth D₁ is slightly larger than the depth D of the remainder of the raceway 32. It will be understood that the maximum depth D₁ may be determined through routine experimentation and may vary from application to application. Factors such as for example, the pitch of the screw 12, the desired load, the speed of rotation, the size of the ball 34, and the size of the nut 18, may be considered to determine the appropriate angle of the arc 42.

Referring again to FIGS. 1 and 2, balls 34 traveling a single circuit of the ball nut assembly 10, enter into contact with both the nut 18 and the screw 12 at the start of an exemplary circuit A at the first part 36′ of the first recessed portion 36. The balls 34 then travel under load in the raceway 32 defined by the helical groove 14 and groove 24, around the outer periphery of the screw 12 to the second recessed portion 38.

The second recessed portion 38 allows the balls 34 to become unloaded while traversing the seam 30. More specifically, the tapered first part 38′ of the recessed portion 38 allows for the gradual reduction of the load on each ball 34 as the ball 34 enters the recessed portion 38. The load on the ball 34 is then gradually reapplied upon exiting the recessed portion 38 through the tapered second part 38″, and returning to the raceway 32 defined by the helical groove 14 and groove 26. The balls 34 then come under load again while traveling the opposite side of the outer periphery of the helical groove 14 (the path of which is illustrated by the balls 34 shown in dashed line), until reaching the second part 36″ of the first recessed portion 36 of the nut 18, wherein the balls 34 again become unloaded.

The first recessed portion 36 is designed in such a way as to allow sufficient space for the balls 34 to simultaneously move radially outward from the screw 12, to travel over the ridge 16 of the screw 12, and axially along the screw 12 a distance approximately equal to one helical pitch, such that each ball 34 is again at the start of a circuit; i.e., at the first part 36′ of the first recessed portion 36.

It will be understood that the balls 34 travel in the circuits B and C in the same manner as described above regarding circuit A. Because the balls 34 pass over the ridge 16 at the first recessed portion 136 in circuit B and over the ridge 16 at the first recessed portion 236 in circuit C, both circuits B and C may include the second recessed portion 38 formed at both the first and second seams 28 and 30.

The embodiments of the ball screw and nut assembly 10 described herein may have any desired pitch, and it will be understood that the optimum pitch may be determined through routine experimentation. The embodiments described and illustrated herein include single start worms 12, wherein the recirculation of the balls 34 back to the start of the raceway 32 defines one pitch. Although not illustrated, the features of the improved ball screw and nut assembly 10 described herein may be used with multiple start worm assemblies.

It will be understood that it is the loading of the screw 12 against the nut 18 through the balls 34 that forces the movement of the balls 34 through the advancing raceways 32. The recessed portion 38 are deep enough to provide clearance of the balls 34 as they pass over the ridges 16.

The nut 18 may be formed from any suitable material. Examples of suitable materials include steel, brass, engineered plastic, and aluminum. Any other suitable metal and non-metal may also be used. The nut 18 may be formed by any suitable method, such as for example; forging or cold forming. Forming the nut 18 in two halves 20 and 22, allow for the grooves 24, 26 and the recessed portions 36, 38, 136, and 236 to be exposed and easily accessible for inspection to ensure compliance with dimensional tolerances and for modification if necessary.

The balls 34 may be loaded into the nut 18 before the first and second portions 20 and 22 are assembled. The first and second portions 20 and 22 may then be assembled around the screw 12 and fastened together by any desired means, such as with fasteners 40.

One or more fasteners 40, such as a threaded fastener, may be provided to attach the first and second portions 20 and 22 together. In the illustrated embodiment the fastener 40 is shown at the first and second longitudinal seams 28 and 30, respectively, between the first and second portions 20 and 22.

Alternatively, fastening of the first and second portions 20 and 22 at one of the longitudinal seams 28, 30 may be accomplished by means of interlocking tabs (not shown) or a tab and slot arrangement (not shown), whereby the interlocked features position the two portions 20 and 22 of the nut 18 and may act as a pivoting hinge. The two portions 20 and 22 of the nut 18 are then secured in place around the worm by the fastener 40 at the other of the longitudinal seams 30, 28.

It will be understood that the position of the first portion 20 relative to the second portion 22 may be adjusted during assembly to achieve a desired pre-load or lash (i.e., movement without load) characteristic of the ball screw and nut assembly 10.

It will be also understood that the second recessed portion 38 may be formed in one or more seams of a nut in a ball screw and nut assembly wherein the nut has more than two component parts, such as for example, three parts or four parts.

It will be further understood that the second recessed portion 38 may be formed in one or more seams of a nut in a ball screw and nut assembly wherein the ball return path is external to the nut. One example of such a ball screw and nut assembly with a ball return bath external to the nut is disclosed in U.S. Pat. No. 7,207,234.

The principle and mode of operation of the ball screw and nut assembly have been described in its various embodiments. However, it should be noted that the ball screw and nut assembly described herein may be practiced otherwise than as specifically illustrated and described without departing from its scope.

What is claimed is:

1. A ball screw and nut mechanism comprising:
a screw having helical grooves with helical ridges therebetween;
a nut formed from at least two portions, the nut having complementary grooves which in combination with the screw grooves define raceways for at least one closed loop of rolling balls;
wherein the nut defines at least first and second seams between the two nut portions; and
wherein the rolling balls circulate in a closed loop to enable the screw, to translate in a linear manner relative to the nut; and
characterized in that:
in the region of at least one seam, the grooves in the nut portions are configured so as to at least partially unload the balls as they roll past the seam.

2. The ball screw and nut mechanism according to claim 1, wherein in the region of at least one seam, a portion of the radius of the grooves is larger than a radius of the balls.

3. The ball screw and nut mechanism according to claim 1, wherein in the region of at least one seam, the grooves have a radius larger than a radius of the balls.

4. The ball screw and nut mechanism according to claim 1, wherein the region is formed in each closed loop at both of the first and second seams, so as to at least partially unload the balls as they roll past each seam.

5. The ball screw and nut mechanism according to claim 4, wherein in the region of at least one seam, a portion of the radius of the grooves is larger than a radius of the balls.

6. The ball screw and nut mechanism according to claim 4, wherein in the region of at least one seam, the grooves have a radius larger than a radius of the balls.

7. The ball screw and nut mechanism according to claim 1, wherein at least one of the grooves in each of the nut portions includes a recessed portion integrally formed therein adjacent the screw threads in the at least one closed loops to allow the rolling balls to return over the helical ridges of the screw, the recessed portion having a pitch different from the pitch of the rest of the groove.
